(19) United States
(12) Patent Application Publication
(10) Pub. No.: US 2020/0225470 A1
(43) Pub. Date: Jul. 16, 2020

(54) HUD ILLUMINATION SYSTEM, HEAD-UP DISPLAY DEVICE ANDREALIZATION METHOD

(71) Applicant: SUZHOU CARROBOT AUTOMOTIVE ELECTRONICS TECHNOLOGY CO., LTD., Suzhou, Jiangsu (CN)

(72) Inventors: Shunping MIAO, Suzhou, Jiangsu (CN); Binbin MA, Suzhou, Jiangsu (CN); Jianfeng MIN, Suzhou, Jiangsu (CN)

(21) Appl. No.: 16/641,213

(22) PCT Filed: Dec. 27, 2017
(86) PCT No.: PCT/CN2017/118987

§ 371 Date: Feb. 21, 2020

(30) Foreign Application Priority Data
Aug. 22, 2017 (CN) 201710725237.X

(51) Int. Cl. G02B 27/01; G02B 27/09; G02B 27/30

(52) U.S. Cl. CPC G02B 27/0101; G02B 27/30; G02B 27/0961

(57) ABSTRACT

An HUD illumination system includes a collimation and homogenization unit and an intensity distribution adjustment unit. The collimation and homogenization unit is configured to convert an incident light source into a collimated and homogenized light beam. The intensity distribution adjustment unit is configured to illuminate with different light intensity distributions according to different points; the collimated beam in the collimation and homogenization unit has uniform illuminance on a beam cross section. The output light beam in the intensity distribution adjustment unit matches an imaging optical system in the HUD. The HUD illumination system matches the HUD optical imaging system so that the illumination beam is focused on the eyebox area, thereby improving the illumination efficiency.

### TECHNICAL FIELD

The disclosure relates to the optical field, LED illumination field and vehicle head-up display (HUD) field, in particular, to a HUD illumination system and an implementation method therefor, which can be applied to a car HUD vehicle head-up display device.

### BACKGROUND

To help the driver view the vehicle information, navigation information and so on during driving, usually the head-up display device HUD is used to optically projects image information near the driver's line of sight, avoiding looking down at the dashboard. With the image projected in the head-up display device, the entire image in the region near the driver's eyes (hereinafter referred to as the eyebox region) can be seen, and the image has a uniform brightness.

In the prior art, a common HUD composition is shown in FIG. 1, which includes mainly an illumination system 1, an illumination LCD 2, an imaging optical system 3, an eyebox region 4 and a projected virtual image 5. The core problems for the illumination system in the HUD are about uniformity, efficiency and volume, specifically,

1) the efficiency refers to that an illumination beam is reflected by the imaging optical system 3 and enters the eyebox region 4 as much as possible to achieve high-efficiency lighting;

2) the uniformity refers to that the virtual image 5 viewed in the eyebox region 4 has to meet the condition that the brightness of each point of the image is uniform;

3) the volume refers to that the head-up display device has a compact volume structure.

To solve above problems, currently, two method are mainly employed, in which one is a reflective method, as shown in FIG. 2, which includes an LED, a reflective surface, and an illumination surface, with a compact structure. The problems existed for this method are that the illumination has a large diffusion angle, the light intensity distribution at each point on the illumination surface is basically uniform, and the light intensity distribution does not match the HUD imaging optical system, so that the illumination efficiency decreases, which affects the brightness of the HUD image. Another one is a lens-array method, which first collimates the LED beam distribution into a non-uniform near-parallel light, and then uses a Köhler illumination light path to adjust the uniformity of the illumination surface.

It solves the problem about uniformity of the illumination surface and illumination efficiency, but the volume of structure is large. To achieve above purposes, the illumination system has to satisfy conditions that 1) the intensity distribution of the illuminated surface LCD should match the HUD imaging optical system; 2) the illumination spaces should distributed uniformly on the illuminated surface LCD.

In addition, HUD has to achieve low power consumption, high brightness, small size and compact structure, in which a very important part is the backlight system. How to provide an illumination system that can reduce system power consumption and ensure compact structure, and to apply it to the head-up display device, is an urgent need.

### SUMMARY

The technical problem to be solved by the disclosure is to provide an HUD illumination system for achieving low power consumption, high brightness, small volume and compact structure of an head-up display device.

The head-up display device in the disclosure at least includes a liquid crystal display panel (LCD), an imaging optical system, and an illumination system. The imaging optical system projects an image displayed on the LCD to form a virtual image in front of a driver. The LCD itself does not emit light, and is illuminated by the illumination system.

To solve above technical problems, the disclosure provides an HUD illumination system, including a collimation and homogenization unit and an intensity distribution adjustment unit, the collimation and homogenization unit is configured to convert an incident light source into a collimated and homogenized light beam, the intensity distribution adjustment unit is configured to illuminate with different light intensity distribution according to different points the collimated beam in the collimation and homogenization unit has uniform illuminance on a beam cross section, and an output light beam in the intensity distribution adjustment unit matches an imaging optical system in the HUD.

Further, the collimation and homogenization unit directly shapes the light beam emitted by the light source into a cross section set according to requirements by refraction or reflection of the light. Further, the collimation and homogenization unit at least includes two optical elements, the two optical elements including a first optical element and a second optical element, the first optical element and the second optical element have a front surface that is a free curved surface and a rear surface that is a flat surface, or, the first optical element and the second optical element have a front surface that is a flat surface and a rear surface that is a free curved surface, or, the first optical element and the second optical element have at least two surfaces that are free curved surfaces.

Further, the intensity distribution adjustment unit includes an optical element for refraction or reflection, which has a light intensity distribution that matches the HUD imaging optical system.

Further, the system further includes a diffusion element configured to scatter the incident light beam, and the diffusion element is any one of a diffusion film or a microlens array.

Further, the HUD illumination system is arranged in an array if the illumination area has to be increased.

Further, in the collimation and homogenization unit, the free curved surface may be a rotationally symmetric aspheric surface when an illumination surface is a circular surface, and/or the free curved surface is a non-rotationally symmetric curved surface when the illuminated surface is a non-circular surface.

Further, in the collimation and homogenization unit, the cross section may be circular, square, or rectangular.

Further, a light exit surface of the homogenized and collimated optical path is a flat surface, and a light incident surface of the intensity distribution adjustment element is a flat surface; at this time, the flat surfaces of the two elements may be combined to reduce the number of elements of the entire illumination system.

Further, the intensity distribution adjustment unit has a light incident surface that is a flat surface, a light exit surface that is a spherical or curved surface, and adjusts a shape of the eyebox by adjusting a distribution form of each azimuth intensity.

Further, in the collimation and homogenization unit, an incident light source beam is converted into a collimated beam by means of refraction, reflection and/or diffraction of the light, and an illuminance on the cross section of the light beam is homogenized.

Based on above, the disclosure further provides a head-up display device, including an illumination system, an illumination LCD, an imaging optical system, an eyebox region 4 and a projected virtual image, a light source beam emitted by the illumination system successively passing through the illumination LCD and the imaging optical system to the eyebox region, the illumination system is the HUD illumination system.

Based on above, the disclosure further provides an implementation method for the HUD illumination system, including steps of:

S1, passing a light beam emitted by a light source through the collimation and homogenization unit, the intensity distribution adjustment unit, the LCD, and the imaging optical system to the eyebox region,

S2, configuring the collimation and homogenization unit to convert an incident light source into a collimated and homogenized light beam,

S3, configuring the intensity distribution adjustment unit to illuminate with different light intensity distribution according to different points,

S4, making an illuminance of the collimated beam in the collimation and homogenization unit be homogenized on a beam cross section, and matching an output light beam in the intensity distribution adjustment unit with an imaging optical system in the HUD.

The beneficial effects of the present invention are:

1) In the HUD illumination system of the disclosure, since it includes a collimation and homogenization unit and an intensity distribution adjustment unit, an incident light source is converted into a collimated and homogenized light beam by the collimation and homogenization unit, and an illuminance of the collimated beam in the collimation and homogenization unit is homogenized on a beam cross section. The intensity distribution adjustment unit is configured to illuminate with different light intensity distribution according to different points, and an output light beam in the intensity distribution adjustment unit matches an imaging optical system in the HUD. Therefore, the HUD illumination system in the disclosure may be matched with the HUD optical imaging system, so that the illumination beam is concentrated in the eyebox region, and the illumination efficiency is improved. And compared with the single-lens homogenization and collimation illumination system, the method of the disclosure improves the exit angle of light on the lens, which is beneficial to improving efficiency.

2) In addition, since the collimation and homogenization unit and the intensity distribution adjustment unit may reduce the number of elements, the overall volume of the illumination system is compact. Compared with the single-lens homogenization and collimation illumination system, the elements used by the homogenized and collimated illumination system have a thinner thickness.

3) The illumination region of The HUD illumination system of the disclosure is not limited to a circle, and may be rectangular, square, or other shapes.

### BRIEF DESCRIPTION OF DRAWINGS

FIG. 1 is a view of a HUD composition in the prior art;

FIG. 2 is a view of a reflective method in the prior art;

FIG. 3 is a view showing a structure of an HUD illumination system in one embodiment of the disclosure;

FIG. 4 is a view of the combined structure in FIG. 3;

FIG. 5 is a view showing a structure of an illumination system in one embodiment of the disclosure;

FIG. 6 is a view showing a light path of a collimation and homogenization unit in one embodiment of the disclosure;

FIG. 7 is a view showing a light path of an intensity distribution adjustment unit in one embodiment of the disclosure;

FIG. 8 is a view showing a structure of an entire microlens array;

FIG. 9 is a view of a front view angle in FIG. 8;

FIGS. 10(a) and 10(b) are views showing structures of an array arrangement in the xy-axis direction and the xz-axis direction;

FIG. 11 is a flow chart of an implementation method for the HUD illumination system of the disclosure.

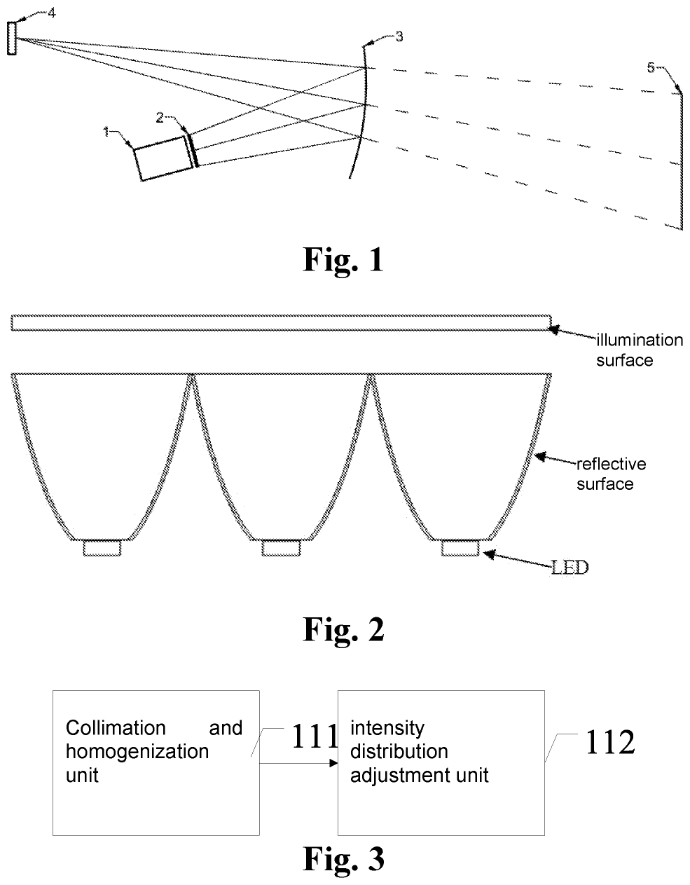

### DESCRIPTION OF EMBODIMENTS

The principles of the present disclosure will now be described with reference to some example embodiments. It is to be understood that these embodiments are described only for the purpose of illustrating and helping those skilled in the art to understand and implement the present disclosure, rather than suggesting any limitation on the scope of the present disclosure. The content of the present disclosure described herein may be implemented in various ways other than those described below. As described herein, the term “including” and its various variations can be understood as an open-ended term that means “including but not limited to.” The term “based on” can be understood as “based at least in part on.” The term “one embodiment” can be understood as “at least one embodiment”. The term “another embodiment” can be understood as “at least one other embodiment”.

With reference to FIG. 3, an HUD illumination system in one embodiment of the disclosure is illustrated, the HUD system includes a collimation and homogenization unit 111 and an intensity distribution adjustment unit 112, wherein the collimation and homogenization unit 111 is configured to convert an incident light source into a collimated light beam, and the intensity distribution adjustment unit 112 is configured to illuminate with different light intensity distributions according to different points; the collimated beam in the collimation and homogenization unit 111 has uniform illuminance on a beam cross section, and an output light beam in the intensity distribution adjustment unit 112 matches an imaging optical system in the HUD. The light source used in the HUD illumination system in the present embodiment may be an LED light emitting diode or an LD semiconductor laser. The light beam emitted by the LD light source is approximately a collimated light beam, and the process of achieving homogenization and collimation is different from that of the LED light source.

For different light sources, the idea of achieving illumination is the same. In the collimation and homogenization unit 111, the method for homogenization and collimation of the light source is not limited, and may be a homogenized and collimated optical path of refraction, or a combination of refraction and reflection. In the intensity distribution adjustment unit 112, the intensity distribution adjustment for the homogenized and collimated light adopts spherical refraction or reflection with combination of light diffusion elements, so that after the illumination light beam passes through the HUD imaging optical system, the beam cross section is basically the same as the eyebox region, or it may be slightly larger than the eyebox region.

In some embodiments, in the HUD illumination system of the present embodiment, a the homogenized and collimated optical path is further provided, which is composed of at least two elements, and directly shapes the light beam emitted by the light source into the required cross section by means of the refraction of light from the optical elements, wherein the cross section includes, but is not limited to, a circle, a square, a rectangle, and the like. Along the transmission direction from the light source, a first element appears first and then a second element. The first element is near the LED and the second element is far from the LED. Specifically, the first element has one surface near the LED that is a flat surface, and the other surface that is a free curved surface. The second element has one surface near the LED that is a free curved surface, and the other surface that is a flat surface. In some embodiments, the first element and the second element have a total of four surfaces, wherein more than one surface is a free curved surface.

In some embodiments, when the above illumination surface is a circular surface, the free curved surface may be a rotationally symmetric aspheric surface.

In some embodiments, when the above illumination surface is a non-circular surface such as a square or a rectangle, the free curved surface may be a non-rotationally symmetric curved surface. Preferably, the light intensity distribution of the LED light source is Lambertian or any other known light intensity distribution form.

In some embodiments, the intensity distribution adjustment unit 112 in the present embodiment may be realized by more than 1 optical element, which may be a refractive or reflective element. Thus, the output light beam matches the HUD imaging optical system, that is, the light intensity distributions illuminated on different points on the LCD are different.

Preferably, a diffusion sheet may be added between the LCD and the optical element to further adjust the intensity distribution, so that the illumination surface becomes uniform and soft.

Preferably, the intensity distribution adjustment element of the intensity distribution adjustment unit 112 has a light incident surface that is a flat surface, and a light exit surface that is a spherical or curved surface.

Preferably, the intensity distribution adjustment element in the intensity distribution adjustment unit 112 adjusts a shape of the eyebox by adjusting a distribution form of each azimuth intensity, such as adjusting the shape of the eyebox as a rectangle, a square and an oval, etc.

Preferably, when a light exit surface of the homogenized and collimated optical path in the collimation and homogenization unit 111 is a flat surface and a light incident surface of the intensity distribution adjustment element is a flat surface, the flat surfaces of the two elements may be combined to reduce the number of elements of the entire illumination system.

Since the collimation and homogenization unit 111 and the intensity distribution adjustment unit 112 may reduce the number of elements, the overall volume of the illumination system is compact. Compared with the single-lens homogenization and collimation illumination system, the elements used by the homogenized and collimated illumination system have a thinner thickness.

Preferably, the HUD illumination system in the present embodiment may be arranged in an array, enlarging the illumination area after splicing. The array includes, but is not limited to an 1×2 array, a 2×2 array, etc., and the arrangement form may be a rectangle, a hexagonal, etc.

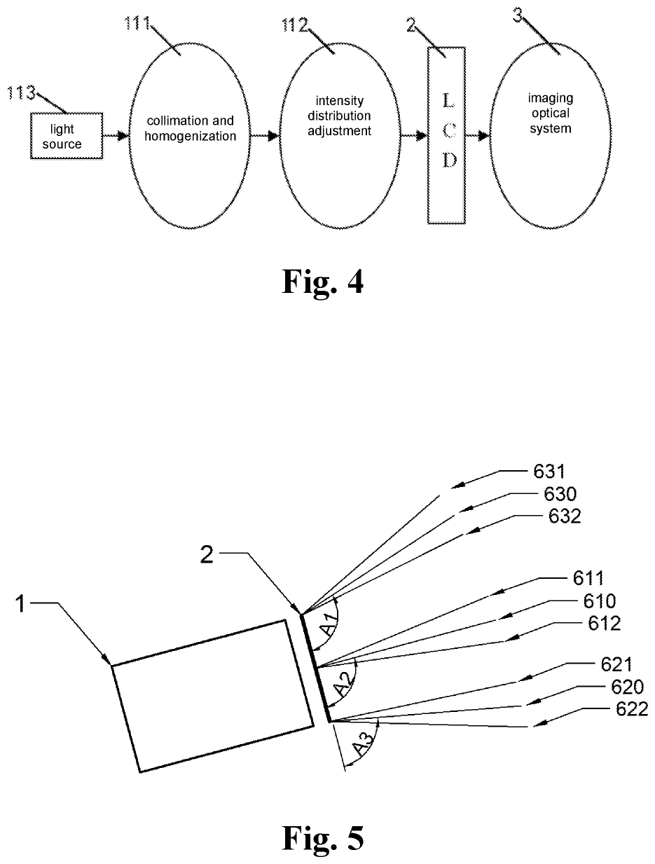

With reference to FIG. 4 illustrating a combined structural view of FIG. 3, a light beam emitted by a light source 113 passes through the collimation and homogenization unit 111, the intensity distribution adjustment unit 112, an LCD2, and the imaging optical system 3 to the eyebox region (not shown).

Since an incident light source beam is converted into a collimated beam by means of refraction, reflection or diffraction of the light, a condition that an illuminance on the cross section of the light beam is homogenized is satisfied in the collimation and homogenization unit 111. The intensity distribution adjustment unit 112 in the present embodiment is realized by more than 1 optical element, which may be a refractive or reflective element. And a condition that the output light beam matches the HUD imaging optical system is satisfied, that is, the light intensity distributions illuminated on different points on the LCD are different. Because the angle of the light exited at each point on the LCD is different from the angle between the LCDs, it is more conducive to matching the HUD imaging optical system and to the application in the head-up display device.

As a preference in the present embodiment, with reference to FIG. 5 illustrating a structure of an illumination system in one embodiment of the disclosure, the illumination system 1 (at least includes a light source 113, a collimation and homogenization unit 111 and an intensity distribution adjustment unit 112) outputs a light beam to be illuminated to the LCD 2. Taking a center point and two upper and lower edges of the LCD as an example, according to the requirements of the HUD imaging optical system, the light intensity distribution of the center point on the LCD within this cross section is indicated by lights 610, 611, and 612 610 is a main light, and 611 and 612 are edge lights, respectively.

At this point, the light is concentrated in the angle formed by the lights 611 and 612, and the light intensity distribution is basically uniform within this angle. Likewise, lights on two edge points are 620 to 621, and 630 to 631. For different points on LCD, the angles between the main light 610, 620 630 and the LCD are respectively A1, A2, A3, wherein generally A1≠A3·A2.

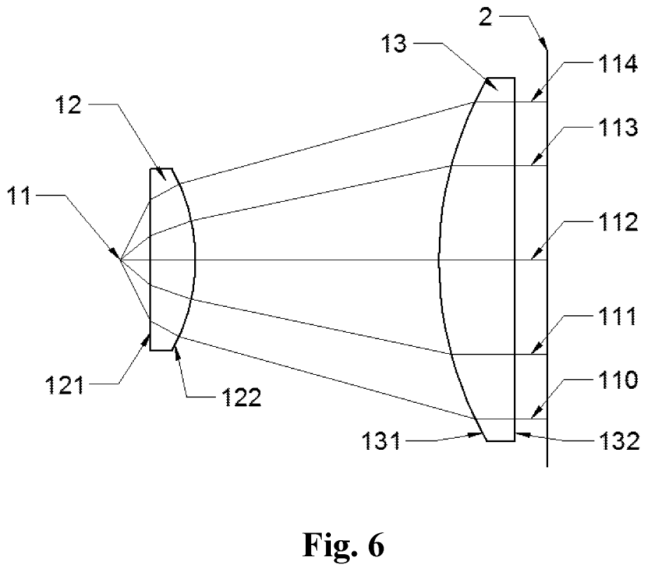

With reference to FIG. 6 illustrating a view showing a light path of a collimation and homogenization unit in one embodiment of the disclosure, the homogenized and collimated optical path in the collimation and homogenization unit 111 in the present embodiment is composed of at least two elements, and directly shapes the light beam emitted by the light source into the required cross section by means of the refraction of light from the optical elements, wherein the cross section includes, but is not limited to, a circle, a square, a rectangle, and the like. As shown in FIG. 6, along the light source transmission direction, the lights that are parallel, as indicated by 110 to 114, emitted from the light source 11 is sequentially irradiated to the LCD 2 through the element 12 and the element 13, wherein the cross section of the illumination spot is basically square and is evenly distributed on the LCD. The elements 12 and 13 are made of optical plastic. Through injection molding, even if the curved surface is complex, rapid mass production may still be achieved. A front surface and a rear surface of the element 12 are respectively 121 and 122. In the present embodiment, the front surface is a flat surface, and the rear surface is a free curved surface. A front surface and a rear surface of the element 13 are respectively 131 and 132. In the present embodiment, the front surface is a free curved surface, and the rear surface is a flat surface; or the front surface may be adjusted to be a flat surface, and the rear surface to be a free curved surface. For the four surfaces of the two elements, at least 2 surfaces are free curved surfaces. Preferably, when the cross section of the illumination spot has a circular shape, the free curved surfaces of the elements 12 and 13 are modified as rotationally symmetric aspheric surfaces. In the present embodiment, the illumination region of The HUD illumination system of the disclosure is not limited to a circle, and may be rectangular, square, or other shapes.

In some embodiments, the collimation and homogenization unit 111 may realize collimation and homogenization by double aspheric lenses to obtain a circular beam cross section. For details, please refer to Chinese Patent CN 103148443 A. However, when the illumination area is larger, the corresponding edge lights on the beam cross section have a large refraction angle at an exit surface of the lens, which affects engineering applications. And as the illumination area increases, the corresponding need for the thickness of the lens increases. Therefore, this embodiment is not applied as a preferred embodiment in the disclosure.

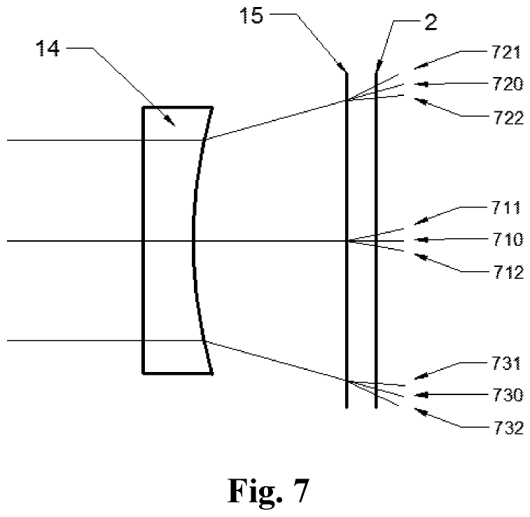

With reference to FIG. 7 illustrating a view showing a light path of an intensity distribution adjustment unit in one embodiment of the disclosure, the intensity distribution adjustment unit 112 may be realized by more than 1 optical element, which may be a refractive or reflective element. The output light beam matches the HUD imaging optical system, that is, the light intensity distributions illuminated on different points on the LCD are different. As shown in FIG. 7, the intensity distribution adjustment unit 112 is composed of an element 14 and an element 15, wherein the element 14 is a refractive element, has a light incident surface that is a flat surface, and has an exit surface that is a curved surface. The element 15 is a diffusion element to diffuse the incident light beam. After reasonably selecting the parameters of elements 14 and 15, and passing the homogenized and collimated light beam to be illuminated on the LCD 2, the light distribution in the cross section, as shown in FIG. 7, includes 710 to 712, 720 to 722, and 730 to 732, respectively, and the intensity distribution matches the HUD imaging optical system.

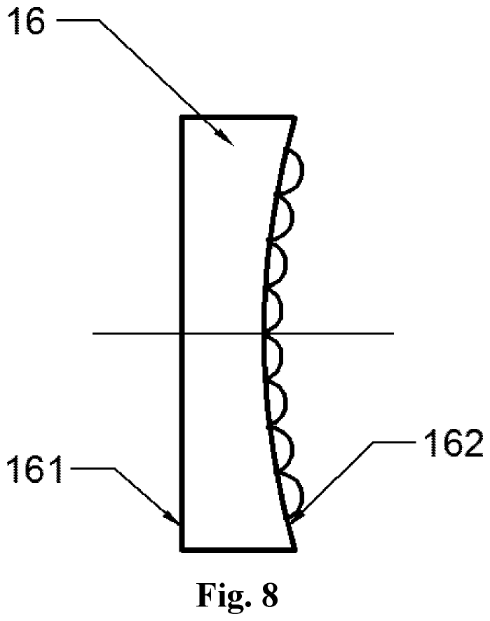

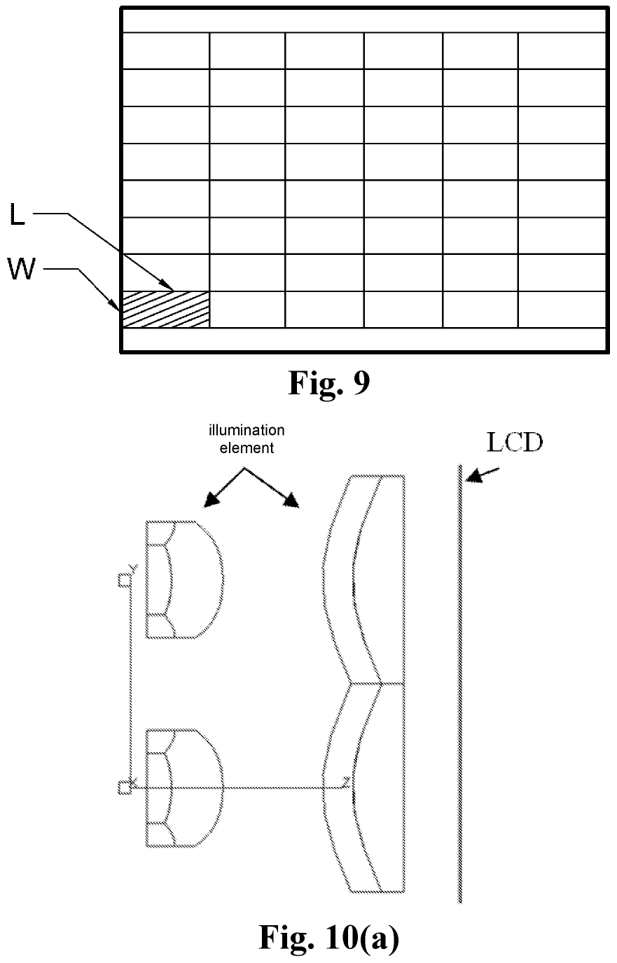

As a preference of the present embodiment, FIG. 8 is a view showing a structure of an entire microlens array, and the above diffusion element 15 may be selected as a diffusion film or a microlens array. The view below is the view of the microlens array. When the element 16 has a front surface 161 that is a flat surface and a rear surface 162 that is a curved surface, the curved surface is fully covered with the microlens array. With reference to FIG. 9 illustrating a view of a front view angle in FIG. 8, the shaded region is one of the microlenses, with a length L and a width W of the microlens. The aspect ratio L/W is generally consistent with the aspect ratio of the eyebox region.

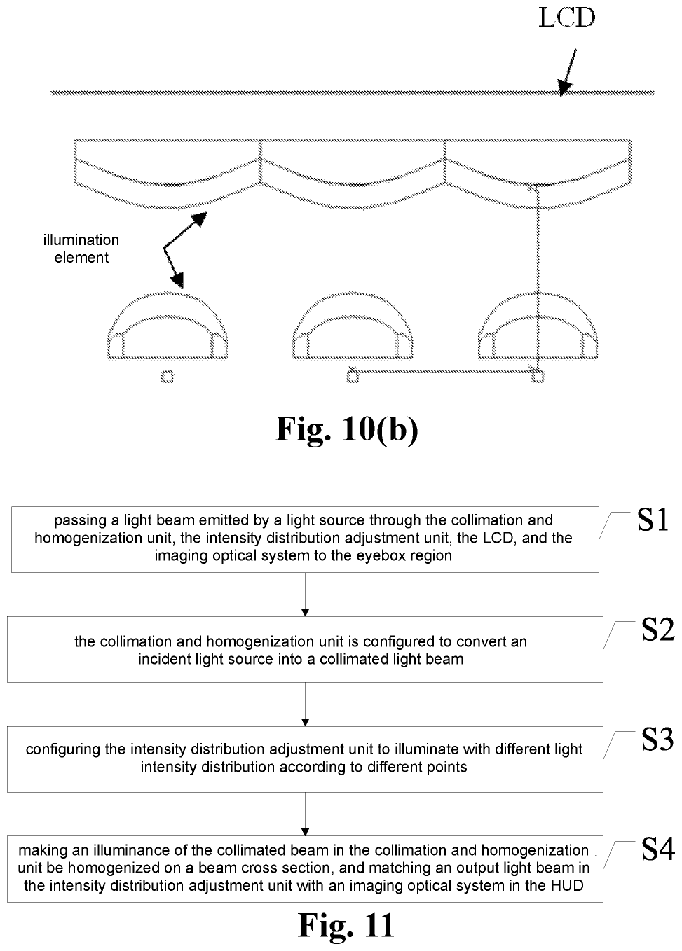

With reference to FIGS. 10(A) and 10(b) illustrating views showing structures of an array arrangement in the xy-axis direction and the xz-axis direction, for the array arragement, the HUD illumination system in the present embodiment may be arranged in an array, enlarging the illumination area after splicing. As shown in FIGS. 10(A) and 10(b), the arrangement is a 2×3 array arrangement. Under the same conditions, the increased illumination area and the increase in the number of LEDs make use of the increase in overall luminous flux. It should be noted that for the array arrangement, the light will cause crosstalk, and a set of lights from the homogenization and collimation HUD illumination systems will crosstalk into another adjacent set. Structural elements may be added for shading. In addition, considering that the angle of light crosstalking into another adjacent set is generally 20 to 40°, the light will not enter the eyebox region after subsequent elements. Therefore, the impact on the final human eye viewing imaging is limited and may be ignored in the present embodiment. The present embodiment further discloses a head-up display device, mainly including an illumination system, an illumination LCD, an imaging optical system, an eyebox region 4 and a projected virtual image, a light source beam emitted by the illumination system successively passing through the illumination LCD and the imaging optical system to the eyebox region, the illumination system is preferably the above HUD illumination system.

Further, the collimation and homogenization unit in the above HUD illumination system at least includes two optical elements, which directly shape the light beam emitted by the light source into a cross section set according to requirements by refraction of the light.

Preferably, the two optical elements in the above HUD illumination system includes a first optical element and a second optical element, wherein the first optical element and the second optical element have a front surface that is a free curved surface and a rear surface that is a flat surface, or, the first optical element and the second optical element have a front surface that is a flat surface and a rear surface that is a free curved surface, or the first optical element and the second optical element have at least two surfaces that are free curved surfaces.

The intensity distribution adjustment unit in the above HUD illumination system includes an optical element for refraction or reflection, which has a light intensity distribution that matches the HUD imaging optical system.

The above HUD illumination system further includes a diffusion element configured to scatter the incident light beam, and the diffusion element is any one of a diffusion film or a microlens array. In some embodiments, the above HUD illumination system is arranged in an array if the illumination area has to be increased for the above HUD illumination system.

In some embodiments, in the above HUD illumination system, the free curved surface may be a rotationally symmetric aspheric surface when an illumination surface is a circular surface, and/or the free curved surface is a non-rotationally symmetric curved surface when the illuminated surface is a non-circular surface.

In some embodiments, for the above HUD illumination system, in the collimation and homogenization unit, the cross section may be circular, square, or rectangular.

In some embodiments, for the above HUD illumination system, a light exit surface of the homogenized and collimated optical path is a flat surface, and a light incident surface of the intensity distribution adjustment element is a flat surface; at this time, the flat surfaces of the two elements may be combined to reduce the number of elements of the entire illumination system.

In some embodiments, for the above HUD illumination system, the intensity distribution adjustment unit has a light incident surface that is a flat surface, a light exit surface that is a spherical or curved surface, and adjusts a shape of the eyebox by adjusting a distribution form of each azimuth intensity. In some embodiments, for the above HUD illumination system, in the collimation and homogenization unit, an incident light source beam is converted into a collimated beam by means of refraction, reflection and/or diffraction of the light, and an illuminance on the cross section of the light beam is homogenized.

With reference to FIG. 11 illustrating a flow chart of an implementation method for the HUD illumination system of the disclosure, the method includes steps of:

step S1, passing a light beam emitted by a light source through the collimation and homogenization unit, the intensity distribution adjustment unit, the LCD, and the imaging optical system to the eyebox region,

step S2, configuring the collimation and homogenization unit to convert an incident light source into a collimated and homogenized light beam, wherein preferably, in the step S2, the collimation and homogenization unit at least includes two optical elements, which directly shape the light beam emitted by the light source into a cross section set according to requirements by refraction of the light.

The two optical elements includes a first optical element and a second optical element, wherein the first optical element and the second optical element have a front surface that is a free curved surface and a rear surface that is a flat surface, or, the first optical element and the second optical element have a front surface that is a flat surface and a rear surface that is a free curved surface, or the first optical element and the second optical element have at least two surfaces that are free curved surfaces.

Step S3, configuring the intensity distribution adjustment unit to illuminate with different light intensity distribution according to different points, wherein in the step S3, the intensity distribution adjustment unit includes an optical element for refraction or reflection, which has a light intensity distribution that matches the HUD imaging optical system, and further includes a diffusion element configured to scatter the incident light beam, and the diffusion element is any one of a diffusion film or a microlens array.

step S4, making an illuminance of the collimated beam in the collimation and homogenization unit be homogenized on a beam cross section, and matching an output light beam in the intensity distribution adjustment unit with an imaging optical system in the HUD.

In above steps, the HUD illumination system is arranged in an array if the illumination area has to be increased.

In above steps, the free curved surface may be a rotationally symmetric aspheric surface when an illumination surface is a circular surface, and/or the free curved surface is a non-rotationally symmetric curved surface when the illuminated surface is a non-circular surface.

In above steps, the cross section may be circular, square, or rectangular.

In above steps, a light exit surface of the homogenized and collimated optical path is a flat surface, and a light incident surface of the intensity distribution adjustment element is a flat surface; at this time, the flat surfaces of the two elements may be combined to reduce the number of elements of the entire illumination system.

In above steps, the intensity distribution adjustment unit has a light incident surface that is a flat surface, a light exit surface that is a spherical or curved surface, and adjusts a shape of the eyebox by adjusting a distribution form of each azimuth intensity.

In above steps, in the collimation and homogenization unit, an incident light source beam is converted into a collimated beam by means of refraction, reflection and/or diffraction of the light, and an illuminance on the cross section of the light beam is homogenized.

In the description of the present specification, descriptions with reference to the term “one embodiment”, “some embodiments”, “an example”, “specific example”, or “some examples” and the like mean that specific features, structures, materials, or characteristics described in conjunction with the embodiments or examples are included in at least one embodiment or example of the disclosure. In the present specification, the schematic representation of the above terms does not necessarily mean the same embodiment or example. Furthermore, the particular features, structures, materials, or characteristics described may be combined in a suitable manner in any one or more embodiments or examples.

In general, the various embodiments of the disclosure may be implemented in hardware or special purpose circuits, software, logic or any combination thereof. Some aspects may be implemented in hardware, while other aspects may be implemented in firmware or software, which may be executed by a controller, microprocessor, or other computing device. Although various aspects of the disclosure are shown and described as block diagrams, flowcharts, or using some other graphical representation, it is to be understood that the blocks, devices, systems, techniques, or methods described herein may be implemented in non-limiting manner by means of hardware, software, firmware, dedicated circuits or logic, general-purpose hardware or controllers, or other computing devices, or some combination thereof.

Furthermore, although operations are described in a particular order, this should not be construed as requiring that such operations be performed in the order shown or in a sequential sequence, or that all illustrated operations be performed to achieve a desired result. In some cases, multitasking or parallel processing may be advantageous. Similarly, although details of several specific implementations are included in the above discussion, these should not be construed as any limitation on the scope of the disclosure, but the description of features is only for specific embodiments. Certain features described in separate embodiments may also be performed in combination in a single embodiment. Conversely, various features that are described in a single embodiment can also be implemented separately in multiple embodiments or in any suitable sub-combination.

1. An HUD illumination system, comprising a collimation and homogenization unit and an intensity distribution adjustment unit,
the collimation and homogenization unit is configured to convert an incident light source into a collimated and homogenized light beam,
the intensity distribution adjustment unit is configured to illuminate with different light intensity distribution according to different points
the collimated beam in the collimation and homogenization unit has uniform illuminance on a beam cross section, and an output light beam in the intensity distribution adjustment unit matches an imaging optical system in the HUD.

2. The HUD illumination system according to claim 1, wherein the collimation and homogenization unit directly shapes the light beam emitted by the light source into a cross section set according to requirements by refraction or reflection of the light.

3. The HUD illumination system according to claim 2, wherein the collimation and homogenization unit at least comprises two optical elements, the two optical elements comprising a first optical element and a second optical element,
the first optical element and the second optical element have a front surface that is a free curved surface and a rear surface that is a flat surface,
or, the first optical element and the second optical element have a front surface that is a flat surface and a rear surface that is a free curved surface,
or, the first optical element and the second optical element have at least two surfaces that are free curved surfaces.

4. The HUD illumination system according to claim 1, wherein the intensity distribution adjustment unit comprises an optical element for refraction or reflection, which has a light intensity distribution that matches the HUD imaging optical system.

5. The HUD illumination system according to claim 4, wherein the system further comprises a diffusion element configured to scatter the incident light beam, and the diffusion element is any one of a diffusion film or a microlens array.

6. The HUD illumination system according to claim 1, wherein the HUD illumination system is arranged in an array if the illumination area has to be increased.

7. The HUD illumination system according to claim 1, wherein in the collimation and homogenization unit, the free curved surface may be a rotationally symmetric aspheric surface when an illumination surface is a circular surface, and/or the free curved surface is a non-rotationally symmetric curved surface when the illuminated surface is a non-circular surface.

8. The HUD illumination system according to claim 1, wherein in the collimation and homogenization unit, the cross section may be circular, square, or rectangular.

9. The HUD illumination system according to claim 1, wherein a light exit surface of the homogenized and collimated optical path is a flat surface, and a light incident surface of the intensity distribution adjustment element is a flat surface; at this time, the flat surfaces of the two elements may be combined to reduce the number of elements of the entire illumination system.

10. The HUD illumination system according to claim 1, wherein the intensity distribution adjustment unit has a light incident surface that is a flat surface, a light exit surface that is a spherical or curved surface, and adjusts a shape of the eyebox by adjusting a distribution form of each azimuth intensity.

11. The HUD illumination system according to claim 1, wherein in the collimation and homogenization unit, an incident light source beam is converted into a collimated beam by means of refraction, reflection and/or diffraction of the light, and an illuminance on the cross section of the light beam is homogenized.

12. A head-up display device, comprising an illumination system, an illumination LCD, an imaging optical system, an eyebox region 4 and a projected virtual image, a light source beam emitted by the illumination system successively passing through the illumination LCD and the imaging optical system to the eyebox region, wherein the illumination system is the HUD illumination system according to claim 1.

13. An implementation method for the HUD illumination system, comprising steps of:
S1, passing a light beam emitted by a light source through the collimation and homogenization unit, the intensity distribution adjustment unit, the LCD, and the imaging optical system to the eyebox region,
S2, configuring the collimation and homogenization unit to convert an incident light source into a collimated and homogenized light beam,
S3, configuring the intensity distribution adjustment unit to illuminate with different light intensity distribution according to different points,
S4, making an illuminance of the collimated beam in the collimation and homogenization unit be homogenized on a beam cross section, and matching an output light beam in the intensity distribution adjustment unit with an imaging optical system in the HUD.
